(19) United States
(12) Patent Application Publication
(10) Pub. No.: US 2023/0035274 A1
(43) Pub. Date: Feb. 2, 2023

(54) Methods and Systems for Classification of Sensitive Electronic Resources

(71) Applicant: Authomize LTD., Tel Aviv (IL)

(72) Inventors: Avi AMINOV, Givat Shmuel (IL); Gal DISKIN, Tel Aviv (IL)

(21) Appl. No.: 17/878,103

(22) Filed: Aug. 1, 2022

Related U.S. Application Data
(60) Provisional application No. 63/228,115, filed on Aug. 1, 2021.

(51) Int. Cl. H04L 9/40

(52) U.S. Cl. CPC H04L 63/104

(57) ABSTRACT

Computerized methods and systems obtain a first resource identifier that identifies a first electronic resource. An association of the first electronic resource with one or more other electronic resources that are identified by resource identifiers in an identifier set is determined. The identifier set includes zero or more resource identifiers that identify electronic resources that are classified as sensitive. A type of environment to which the first electronic resource belongs is determined. A number of users in a user set that are associated with the first electronic resource is computed. The user set includes zero or more users that are classified as users of interest. A determination of whether the first electronic resource is sensitive is made based on a combination of the determined association, determined type of environment, and computed number of users.

### CROSS-REFERENCE TO RELATED APPLICATIONS

This application claims priority from US Provisional Patent Application No. 63/228,115, filed Aug. 1, 2021, whose disclosure is incorporated by reference in its entirety herein.

### TECHNICAL FIELD

The present invention relates to computer security, and more particularly to the sensitivity attributed to electronic resources.

### BACKGROUND OF THE INVENTION

Organizations often maintain and manage different types of electronic resources. When dealing with electronic resources, it is often desirable to be able to determine the sensitivity an organization attributes to a resource. The sensitivity an organization attributes to a resource is likely to affect the security controls governing that resource.

### SUMMARY OF THE INVENTION

Aspects of the present invention provide methods and systems that determine sensitivity of electronic resources. These methods and systems classify electronic resources according to sensitivity by identifying the sensitivity that an organization attributes to electronic resources.

Embodiments of the present invention are directed to a method for determining a sensitivity of electronic resources. The method is executed by a processor coupled to a non-transitory computer readable storage medium. The method comprises: obtaining a first resource identifier that identifies a first electronic resource; determining an association of the first electronic resource with one or more other electronic resources that are identified by resource identifiers in an identifier set, the identifier set including zero or more resource identifiers that identify electronic resources that are classified as sensitive; determining a type of environment to which the first electronic resource belongs; computing a number of users in a user set that are associated with the first electronic resource, the user set including zero or more users that are classified as users of interest; and determining if the first electronic resource is sensitive based on a combination of the determined association, determined type of environment, and computed number of users.

Optionally, the first resource identifier is selected as a selected resource identifier from a set of resource identifiers, and the method iterates on each resource identifier in the set of resource identifiers.

Optionally, the method further comprises: adding the first resource identifier to the identifier set if the first electronic resource is determined to be sensitive.

Optionally, the method further comprises: deriving at least one label that is indicative of at least one reason for the first electronic resource to be determined as sensitive.

Optionally, determining the association of the first electronic resource with the one or more other electronic resources that are identified by resource identifiers in the identifier set includes, for each one electronic resource of the one or more other electronic resources, performing one or more of: i) determining that the first electronic resource and the one electronic resource belong to a same group of electronic resources, ii) determining that the first electronic resource and the one electronic resource share a common environment, iii) determining that the first electronic resource and the one electronic resource have similar tags, iv) determining that the first electronic resource and the one electronic resource are stored together, and v) determining that the first electronic resource and the one electronic resource share a common networking environment.

Optionally, the method further comprises: receiving a plurality of logs, each log associated with at least one electronic resource and recording operations performed by or on the at least one electronic resource, and determining the association of the first electronic resource with the one or more other electronic resources that are identified by resource identifiers in the identifier set includes, for each one electronic resource of the one or more other electronic resources, performing one or more of: i) determining that a number of the plurality of logs that are associated with the first electronic resource and the one electronic resource over a pre-configured period of time exceeds a threshold, ii) determining that a ratio between a number of the plurality of logs that are associated with the first electronic resource and the one electronic resource over a pre-configured period of time and a total number of the plurality of logs in the same pre-configured period of time exceeds a threshold, iii) determining, based on the plurality of logs, that a size of a set of identities using both the first electronic resource and the one electronic resource is above a threshold, and iv) applying a clustering algorithm to the plurality of logs, and determining, based on the clustering algorithm, that the first electronic resource and the one electronic resource belong to a same cluster or community.

Optionally, determining a type of environment to which the first electronic resource belongs includes: retrieving metadata information associated with the first electronic resource, checking the retrieved metadata information for matches with one or more string patterns to produce one or more matched patterns, and determining the type of environment based at least on the one or more matched patterns.

Optionally, determining a type of environment to which the first electronic resource belongs further includes: receiving at least one log associated with the first electronic resource and recording operations performed by or on the first electronic resource, identifying one or more patterns of use of the first electronic resource from the received at least one log to produce one or more identified patterns, and determining the type of environment based on a combination of the one or more matched patterns and the one or more identified patterns.

Optionally, computing the number of users in the user set that are associated with the first electronic resource includes: for each user in the user set, determining an association with the first electronic resource based on metadata associated with the first electronic resource.

Optionally, the method further comprises: receiving at least one log associated with the first electronic resource and recording operations performed by or on the first electronic resource, and computing the number of users in the user set that are associated with the first electronic resource includes: for each user in the user set, determining that the user is associated with the first electronic resource if the user and the first electronic resource are identified in a same one of the at least one log.

Optionally, each user in the user set is selected from the group consisting of: a human user, and an automatic agent.

Optionally, at least some of the users in the user set are human users, and each human user in the user set is classified as a user of interest based on analyzing an organizational chart that represents relationships between the human users in an organization.

Optionally, the combination is a weighted combination.

Optionally, the method further comprises: if the first electronic resource is determined to be sensitive, prompting a user to confirm the determination of sensitivity of the first electronic resource.

Embodiments of the present invention are directed to a computer system for determining a sensitivity of electronic resources. The computer system comprises a processor coupled to a non-transitory computer readable storage medium. The processor is configured to: obtain a first resource identifier that identifies a first electronic resource, determine an association of the first electronic resource with one or more other electronic resources that are identified by resource identifiers in an identifier set, the identifier set including zero or more resource identifiers that identify electronic resources that are classified as sensitive, determine a type of environment to which the first electronic resource belongs; computing a number of users in a user set that are associated with the first electronic resource, the user set including zero or more users that are classified as users of interest, and determine if the first electronic resource is sensitive based on a combination of the determined association, determined type of environment, and computed number of users.

Embodiments of the present invention are directed to a computer usable non-transitory storage medium having a computer program embodied thereon for causing a suitable programmed system to determine a sensitivity of electronic resources, by performing the following steps when such program is executed on the system: obtaining a first resource identifier that identifies a first electronic resource; determining an association of the first electronic resource with one or more other electronic resources that are identified by resource identifiers in an identifier set, the identifier set including zero or more resource identifiers that identify electronic resources that are classified as sensitive; determining a type of environment to which the first electronic resource belongs; computing a number of users in a user set that are associated with the first electronic resource, the user set including zero or more users that are classified as users of interest; and determining if the first electronic resource is sensitive based on a combination of the determined association, determined type of environment, and computed number of users.

Embodiments of the present invention are directed to a method for determining a sensitivity of electronic resources. The method is executed by a processor coupled to a non-transitory computer readable storage medium. The method comprises the steps of: a) obtaining a first identifier set that includes one or more resource identifiers that identify one or more corresponding electronic resources; b) obtaining a second identifier set that includes zero or more resource identifiers that identify electronic resources that are classified as sensitive; c) determining an association of the electronic resource identified by a selected resource identifier in the first identifier set with one or more other electronic resources that are identified by resource identifiers in the second identifier set; d) determining a type of environment to which the electronic resource identified by the selected resource identifier in the first identifier set belongs; e) computing a number of users in a user set that are associated with the electronic resource identified by the selected resource identifier in the first identifier set, the user set including zero or more users that are classified as users of interest; f) determining if the electronic resource identified by the selected resource identifier in the first identifier set is sensitive based on a combination of the determined association, determined type of environment, and computed number of users; and g) iterating steps c)-f) a number of iterations, at each iteration using a selected resource identifier different from the selected resource identifier used in the previous iteration, until at least one stopping condition is satisfied.

Optionally, satisfying the at least one stopping condition includes reaching a maximum number of iterations.

Optionally, satisfying the at least one stopping condition includes the first identifier set being empty or the second identifier set not being updated.

Optionally, the method further comprises the step of: removing the resource identifier from the first identifier set and adding the resource identifier to the second identifier set if at step f) the electronic resource identified by the selected resource identifier in the first identifier set is determined to be sensitive.

Optionally, satisfying the at least one stopping condition includes a number of resource identifiers in the second identifier set exceeding a threshold value.

Embodiments of the present invention are directed to a computer system for determining a sensitivity of electronic resources. The computer system comprises a processor coupled to a non-transitory computer readable storage medium. The processor is configured to perform the following steps: a) obtain a first identifier set that includes one or more resource identifiers that identify one or more corresponding electronic resources, b) obtain a second identifier set that includes zero or more resource identifiers that identify electronic resources that are classified as sensitive, c) determine an association of the electronic resource identified by a selected resource identifier in the first identifier set with one or more other electronic resources that are identified by resource identifiers in the second identifier set, d) determine a type of environment to which the electronic resource identified by the selected resource identifier in the first identifier set belongs, e) compute a number of users in a user set that are associated with the electronic resource identified by the selected resource identifier in the first identifier set, the user set including zero or more users that are classified as users of interest, f) determine if the electronic resource identified by the selected resource identifier in the first identifier set is sensitive based on a combination of the determined association, determined type of environment, and computed number of users, and g) iterate steps c)—f) a number of iterations, at each iteration using a selected resource identifier different from the selected resource identifier used in the previous iteration, until at least one stopping condition is satisfied.

Embodiments of the present invention are directed to a computer usable non-transitory storage medium having a computer program embodied thereon for causing a suitable programmed system to determine a sensitivity of electronic resources, by performing the following steps when such program is executed on the system: a) obtaining a first identifier set that includes one or more resource identifiers that identify one or more corresponding electronic resources; b) obtaining a second identifier set that includes zero or more resource identifiers that identify electronic resources that are classified as sensitive; c) determining an association of the electronic resource identified by a selected resource identifier in the first identifier set with one or more other electronic resources that are identified by resource identifiers in the second identifier set; d) determining a type of environment to which the electronic resource identified by the selected resource identifier in the first identifier set belongs; e) computing a number of users in a user set that are associated with the electronic resource identified by the selected resource identifier in the first identifier set, the user set including zero or more users that are classified as users of interest; f) determining if the electronic resource identified by the selected resource identifier in the first identifier set is sensitive based on a combination of the determined association, determined type of environment, and computed number of users; and g) iterating steps c)-f) a number of iterations, at each iteration using a selected resource identifier different from the selected resource identifier used in the previous iteration, until at least one stopping condition is satisfied.

Embodiments of the present invention are directed to a method for determining a sensitivity of electronic resources. The method is executed by a processor coupled to a non-transitory computer readable storage medium. The method comprises: obtaining a first resource identifier that identifies a first electronic resource; performing one or more of: i) determining an association of the first electronic resource with one or more other electronic resources that are identified by resource identifiers in an identifier set, the identifier set including zero or more resource identifiers that identify electronic resources that are classified as sensitive, ii) determining a type of environment to which the first electronic resource belongs, and iii) computing a number of users in a user set that are associated with the first electronic resource, the user set including zero or more users that are classified as users of interest; and determining if the first electronic resource is sensitive based on a combination of one or more of the determined association, determined type of environment, and computed number of users.

Embodiments of the present invention are directed to a computer system for determining a sensitivity of electronic resources. The computer system comprises a processor coupled to a non-transitory computer readable storage medium. The processor is configured to: obtain a first resource identifier that identifies a first electronic resource, perform one or more of: i) determine an association of the first electronic resource with one or more other electronic resources that are identified by resource identifiers in an identifier set, the identifier set including zero or more resource identifiers that identify electronic resources that are classified as sensitive, ii) determine a type of environment to which the first electronic resource belongs, and iii) compute a number of users in a user set that are associated with the first electronic resource, the user set including zero or more users that are classified as users of interest, and determine if the first electronic resource is sensitive based on a combination of one or more of the determined association, determined type of environment, and computed number of users.

Embodiments of the present invention are directed to a computer usable non-transitory storage medium having a computer program embodied thereon for causing a suitable programmed system to determine a sensitivity of electronic resources, by performing the following steps when such program is executed on the system: obtaining a first resource identifier that identifies a first electronic resource; performing one or more of: i) determining an association of the first electronic resource with one or more other electronic resources that are identified by resource identifiers in an identifier set, the identifier set including zero or more resource identifiers that identify electronic resources that are classified as sensitive, ii) determining a type of environment to which the first electronic resource belongs, and iii) computing a number of users in a user set that are associated with the first electronic resource, the user set including zero or more users that are classified as users of interest; and determining if the first electronic resource is sensitive based on a combination of one or more of the determined association, determined type of environment, and computed number of users.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of an architecture of an exemplary system for determining sensitivity of electronic resources, according to embodiments of the present disclosure;

FIG. 2 is a diagram illustrating an example environment in which a system for determining sensitivity of electronic resources according to an embodiment of the present disclosure can be deployed;

FIG. 3 is a flow diagram illustrating a process for determining sensitivity of electronic resources, according to an embodiment of the present disclosure;

FIG. 4 is a flow diagram illustrating a process for determining an association between electronic resources, which can be used in one of the steps of the process of FIG. 3, according to an embodiment of the present disclosure;

FIG. 5 is a flow diagram illustrating a process for determining a type of environment to which an electronic resource belongs, which can be used in one of the steps of the process of FIG. 3, according to an embodiment of the present disclosure; and

FIG. 6 is a flow diagram illustrating a process for determining a number of users associated with an electronic resource, which can be used in one of the steps of the process of FIG. 3, according to an embodiment of the present disclosure.

### DESCRIPTION OF THE PREFERRED EMBODIMENTS

Embodiments of the present invention provide methods and systems for determining sensitivity of electronic resources.

The principles and operation of the methods and systems according to the present invention may be better understood with reference to the drawings accompanying the description.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

By way of introduction, a non-exhaustive list of examples of electronic resources often maintained and managed by organizations (also often referred to as enterprises) include: electronic files (such as documents, presentations, spreadsheets, web pages, etc.), emails, mail boxes, personal calendars, financial records, customer relationship management (CRM) records, human resources (HR) records, computer source code, computer servers (both physical and virtual) such as storage servers, database servers, web servers, application servers, and the like, containers, desktop computers, laptop computers, mobile computers, and network equipment (such as switches, routers, firewalls, proxies, etc.).

It should be appreciated that in many cases, such electronic resources can also be grouped. For example, files could be placed in a directory structure where a directory implicitly groups all files under it. As another example, a set of virtual machines hosted in a public or private cloud environment could be placed in a resource group or share the same subnet. In yet a further example, multiple database entries could be stored in the same database table. Such groups can also be considered electronic resources by themselves.

Parenthetically, within the context of the present document the terms “electronic resource” and “resource” are used interchangeably. Thus, whenever the term “resource” is used herein, it should be assumed that the resource is an electronic resource unless explicitly stated otherwise.

Embodiments of the present invention provide methods and systems that determine sensitivity of electronic resources, and more specifically that classify electronic resources according to sensitivity by identifying the sensitivity that an organization attributes to each electronic resource. This, in general is achieved, inter alia, by taking into account the environment the electronic resource belongs to, the association of the electronic resource with other sensitive electronic resources as well as, when applicable, whether the electronic resource is associated with users of interest.

For example, an organization might process tens of thousands of emails per day, but not all emails would have the same sensitivity. For example, an email sent to the Chief Executive Officer (CEO) of the organization is likely to be more sensitive than an email sent to a junior employee. To this end, an organization might want that any sensitive email (such as an email sent to the CEO) undergo more stringent security checks in order to identify whether or not the email is malicious.

As another example, a company might attribute a higher sensitivity to production environments than to development or testing/staging environments. The rationale behind this sensitivity attribution is that a degradation in production environment could easily affect the customers of the organization. In addition, a production environment is more likely to contain sensitive information, which could also be subject to regulations such as financial or health records whereas a development, test or stage environment could instead contain mock or anonymized data. As such, an organization may wish to limit the ability to make modifications to a production environment to only a select list of employees or organization members, having undergone a strict authentication process and that such modifications would only be possible if performed from a limited set of networks. In addition, in certain situations, an organization may wish to altogether limit read access of a production environment to only a select list of employees or organization members that have undergone a strict authentication process.

As another example, a web server could serve as an interface to a database in which sensitive financial information is stored or maintained. The web server (a first electronic resource) could be considered to be associated with the database (a second electronic resource). This association could be inferred based on the fact that the two electronic resources are deployed in the same subnet, belong to the same resource group, or by the existence of a large number of log records documenting the interaction of the two electronic resources.

As another example, the file resources that employees of the HR department and the group of managers in the organization collaborate on (based on activity logs) are likely to pertain to several categories of importance such as, for example, paychecks, employment contracts, and employee evaluations. After discovering the set of files used by these groups (who were already identified based on the user metadata), metadata-like file storage hierarchy can be used to find folders/locations and identify likely usage patterns based on elements such as file name and access patterns. For example, a contract is likely to be edited only close to the creation time and rarely viewed. Employee evaluations are periodic, for example having a 6-month or 12-month period, while paychecks are likely to be created on a monthly or bi-weekly (every two weeks) cadence and possibly shared also with the employee and/or accounting users.

A determination of whether electronic resources are sensitive or not sensitive could be beneficial, for example when analyzing an organizational security posture as dictated by the security policy of the organization or when such an organization performs changes to such a policy. In such circumstances, through such a determination, elements of the security policy that relate to electronic resources determined to be sensitive could be highlighted and a more in-depth analysis of these elements could be performed. For example, when a change in the security policy of the organization is contemplated and the change involves an electronic resource of high sensitivity, that change would be required to undergo a more stringent review process.

An organization might consider a resource as sensitive for various reasons. For example, a health record maintained by a hospital is likely to be considered sensitive due to the fact that there are regulations in place such as the Health Insurance Portability and Accountability Act (HIPAA) requiring the hospital to treat health records as confidential. As another example, a key vault storing private cryptographic keys is likely to be considered sensitive as exposure of cryptographic keys is likely to affect the IT security of the organization. It should also be noted that an electronic resource might be considered sensitive for multiple reasons. Thus, each sensitive electronic resource can be associated with one or more labels (also sometimes referred to as classes) indicating the reasons for the sensitivity of the electronic resource. These labels, and hence the reasons indicated by the labels, provide a level of sensitivity of a “sensitive” electronic resource.

As mentioned above, embodiments of the present invention provide methods and systems for identifying the sensitivity an organization attributes to an electronic resource by taking into account the environment the electronic resource belongs to, the association of the electronic resource with other sensitive resources, as well as whether the electronic resource is associated with users of interest. In order to better explain the methods and systems according to embodiments of the present invention in detail, there is initially provided herein a description of the features that are utilized by the methods and systems of the present invention to perform such identifying of the sensitivity of electronic resources. Those features include environments, metadata information associated with electronic resources, identifiers, logs, and users. Each of these features will now be discussed.

When developing and deploying software, it is customary to use separate groups of electronic resources into which the software is deployed and executed. These groups of resources are often referred to as environments. A common development pattern involves the use of at least two types of such environments. A non-limiting list of examples of types of such environments includes: i) a development environment, which is the environment in which software changes are originally made, ii) a production environment, which is the environment used by the end users of the product or service, and iii) a testing or staging environment, which acts as an intermediate environment between the development and production environments. In some cases more than one testing or staging environment might be used. These testing or staging environments are used for staging, testing and perhaps limited use of the new or modified products or services before the changes are deployed into the production environment.

Such environments may vary in size, but often each contain the same core components. For example, a production environment might comprise hundreds of virtual machine instances deployed in multiple geographic locations whereas a testing or staging environment might be confined to a single geographic location and comprise a handful of virtual machine instances executing similar components.

Metadata information associated with resources belonging to the aforementioned environments is often stored in one or more directories. The metadata information may typically be retrieved from such directories using any suitable technique including, for example, one or more of an Application Programming Interface (API), a network protocol, or a file system. For example, Amazon Web Services (AWS) is a well-known cloud computing platform in which such environments are often deployed. Metadata information associated with resources in the AWS platform can be retrieved using an API as well as by any client implementing a documented protocol specified by AWS. Using, for example, the AWS API, it is possible to retrieve metadata information associated with the set of virtual machine instances deployed in AWS.

In addition, metadata information associated with a resource is also often present when a resource is in transit as well as when the resource is at rest. Metadata information associated with a resource in transit can be found in headers or trailers of the protocol used when transmitting the resource. For example, when transporting (transmitting) a resource using TCP/IP, such metadata information can be found in the IP header (IPv4 or IPv6) and the layer 4 header (TCP, UDP, SCTP, etc.) including the IP addresses and port numbers of the sender and the receiver. As another example, when transporting a resource using the HTTP protocol, such metadata information can be found in the HTTP headers such as, for example, Content-Encoding, Content-Length, Content-Type, Cookie, From, Host, Origin, Referer [sic], User-Agent, Content-Disposition, Date, etc. As yet another example, when transporting a resource using the SMTP protocol, such metadata can be found in the SMTP headers.

Metadata information associated with a resource at rest can be found in various places. For example, metadata information associated with a resource at rest can be found in headers or trailers found in the resource itself. For example, when dealing with emails, metadata information can be found in headers defined in RFC822 (and its subsequent updates) including by way of example “From”, “To”, “Cc”, “Bcc”, “Subject”, “Content-Type”, etc. In addition, such metadata information in emails can be used to determine whether the emails contain attachments and to extract metadata information about such attachments including the type, name and size of the attachments. As another example, when a resource at rest is kept in a database, metadata information can be found in related columns in the database entry containing the resource. Such metadata information could include information about the time the entry, including the resource, was created, modified or accessed, as well as the identity of the user responsible for creating or modifying the entry or the identity of the user to whom the entry relates. As yet another example, when a resource is a file or a directory found in a file system, the file system often keeps (stores) metadata information on the resource including, for example, the resource name, resource suffix, resource location within the file system, as well as the creation time, last modification time, last access time and access control permissions of the resource. The metadata information kept by the file system could also include the identity of the user who created or modified the resource, the identity of the user who is allowed to access the file, or the identity of the user to whom the resource relates.

The metadata information associated with a resource can also include one or more of: i) tags or labels associated with the resource. These tags or labels are often used in managing the resources. For example, a tag could identify the username of the person who deployed the resource or manages the resource; ii) the name of the project or resource group to which the resource belongs; iii) the billing information associated with resource; and iv) permissions to modify, create or delete the resource including the identity of the user responsible for creating or modifying the resource or the identity of the user to whom the resource relates.

A resource is usually associated with at least one identifier that unambiguously (uniquely) identifies the resource. For example, a file on a file system could be unambiguously identified by the complete path, including the file name on the file system. Other examples of such identifiers could be a Uniform Resource Identifier (URI) including in the form of a Uniform Resource Locator (URL) or a Uniform Resource Name (URN). In other cases the identifier could be represented using a Universal Unique Identifier (UUID). As another example, the AWS platform uses its own naming convention, where, for example, each virtual machine instance has an identifier in the form of i-[number], and similarly, each virtual volume has an identifier in the form of vol-[number]. An address associated with the resource such as an IP or Ethernet MAC address could also serve as such an identifier.

Logs

In addition, a resource could also be associated with logs that record operations performed by or on a resource. By recording such operations, such logs can include information related to the resource, and thus can inherently include metadata information. Such logs could be generated by the resource itself. For example, a resource such as a web server processing a web request generated by a web client could normally generate a log. Such a log would include information (which can include metadata information associated with the resource) related to the processed web request, such as the time the operation was performed, the address of the web client, the HTTP method, the URL, the request status code issued by the web server, the username performing the web request and the like.

Such logs could also be generated by a second resource interacting or otherwise associated with the first resource. For example, the web client generating the web request in the previous example could generate a log containing information related to the web request. Such a log could, for example, be kept in the history file of the web client.

Logs could also be generated by intermediate resources such as network equipment including routers, switches, firewalls and proxies through which the operations are performed. For example, a web proxy could log the client request from the previous example.

Logs can also be generated by a management platform that manages the lifecycle and configuration of a resource. For example, most public and private cloud systems generate audit logs containing information on the lifecycle of resources managed by the public and private cloud systems, including, for example, creation, termination, and state transitions of the resources. The audit logs could also document changes in the configuration of the resource.

A resource could be associated with a log by virtue of the log referencing the resource. Such a reference could be made, for example, by the log including a resource identifier that unambiguously identifies the resource.

The logs could be stored as regular files on a file system, as objects in an object storage system or in a database. The logs could be retrieved using an API, through a network protocol, or via any other suitable means.

The term user as used herein should be interpreted to refer not only to an actual person utilizing a computer system or a service, but also to an automatic agent working in a similar fashion. Users are managed through the use of directories where attributes on the users are stored. Users are often associated with credentials and/or keys that are used to authenticate the users to computer systems or services they utilize.

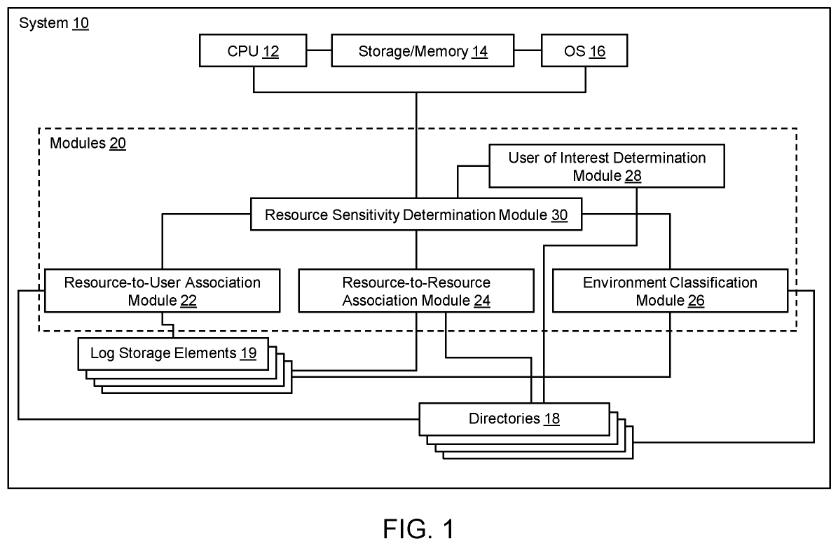

Bearing all of the above in mind, attention is directed to FIG. 1 which illustrates an exemplary system 10 according to embodiments of the present disclosure as an architecture. The system 10 provides logic and logic functions, and is generally configured to determine sensitivity of electronic resources using the logic and logic functions based upon received input.

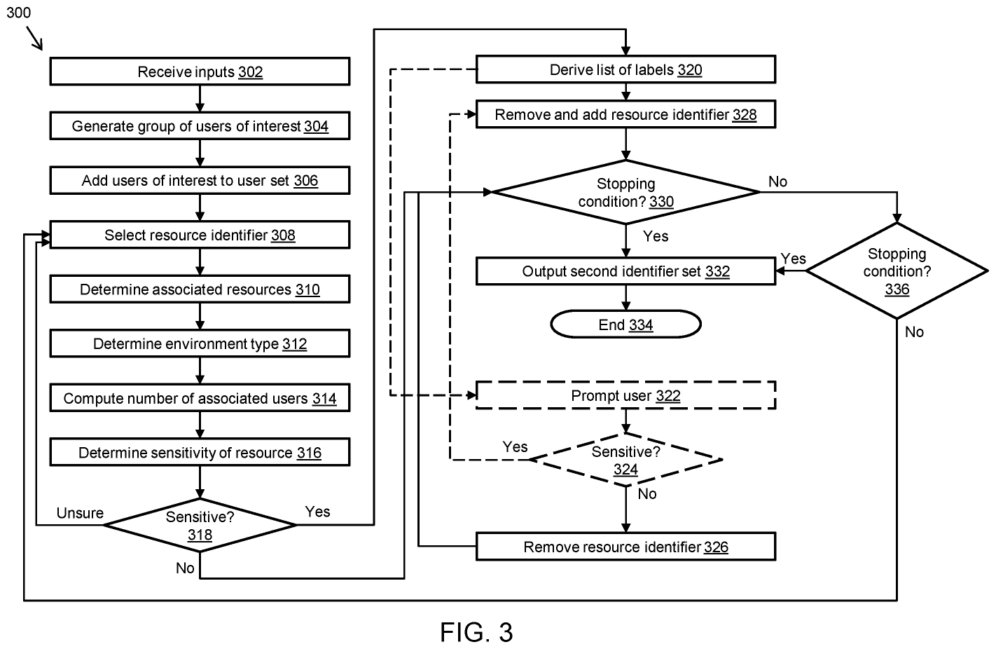

The system 10 includes a central processing unit (CPU) 12 formed from one or more processors, including hardware processors, and performs the processes (methods) of the present disclosure, such as those shown in the flow diagrams of FIGS. 3-6, and detailed below. These processes of FIGS. 3-6 may be in the form of programs, algorithms and the like. The processors of the CPU 12 can, for example, be conventional processors, such as those used in servers, computers, and other computerized devices. For example, the processors may include x86 Processors from AMD and Intel, Xeon® and Pentium® processors from Intel, as well as any combinations thereof. In other embodiments, the processors can be special-purpose or application-specific processors.

The CPU 12 is electronically coupled (connected) to a storage/memory 14 for storing machine executable instructions, executable by the CPU 12, for performing the processes of the present disclosure, such as those shown in the flow diagrams of FIGS. 3-6, as will be detailed in subsequent sections of this document. The storage/memory 14, although shown as a single component for representative purposes, may be multiple components. The CPU 12 is also electronically coupled (connected), either directly or indirectly, to various modules 20 (computer components) that are configured to perform the various logic functions of the present disclosure. The CPU 12 is further electronically coupled (connected) to an operating system (OS) 16 that may load machine executable instructions, stored in the storage/memory 14, for execution by the CPU 12. The OS 16 may include any of the conventional computer operating systems, such as those available from Microsoft of Redmond Wash., commercially available as Windows® OS, such as Windows® 10, Windows® 7, MAC OS from Apple of Cupertino, Calif., or Linux, or may include real-time operating systems, or may include any other type of operating system typically deployed in computer systems as known in the art.

The aforementioned modules 20 (computer components) are part of, or communicatively coupled to, the system 10, and are configured to perform the various logic functions of the disclosed embodiments. Typically, the system 10 includes software, software routines, computer program code, computer program code segments and the like, embodied, for example, in modules, computer components, and the like (exemplarily illustrated as computer modules 20). The computer modules 20, as computer components, are stored in a non-transitory computer readable storage medium, which is preferably one of the components of the storage/memory 14 or another non-transitory computer readable storage medium electronically coupled to the CPU 12, such that the machine executable instructions stored in the computer modules 20 can be loaded and executed by the CPU 12.

The CPU 12, for example, typically in conjunction with the storage/memory 14 and/or another non-transitory computer readable storage medium that stores the computer modules 20, runs the aforementioned programs or algorithms of FIGS. 3-6, as detailed below. The aforementioned programs or algorithms are, for example, represented in various forms including machine language/machine code for various types of processors, assembly for various types of processors, Java byte code, or in a programming language such as the “C” programming language, Java, JavaScript, Python, Go, C# or other programming languages, as well as intermediate representations of the programming languages.

In the non-limiting exemplary embodiment illustrated in FIG. 1, the computer modules 20 include a resource-to-user association module 22, a resource-to-resource association module 24, an environment classification module 26, a user of interest determination module 28, and a resource sensitivity determination module 30.

With continued reference to FIG. 1, the system 10 uses one or more directories 18 which can store metadata information associated with resources. In the illustrated embodiment, the directories 18 are part of the system 10, however in other embodiments the directories 18 are external to the system 10 and are communicatively coupled to components of the system 10 through an API, network protocol, file system, or any other suitable means.

The system 10 also uses one or more log storage elements 19 for storing logs that record operations performed by or on resources. The log storage elements 19 can be, for example, one or more file systems, one or more object storage systems, one or more databases, and the like. In the illustrated embodiment, the log storage elements 19 are part of the system 10, however in other embodiments the log storage elements 19 are external to the system 10 and are communicatively coupled to components of the system 10 through an API, a network protocol, or any other suitable means.

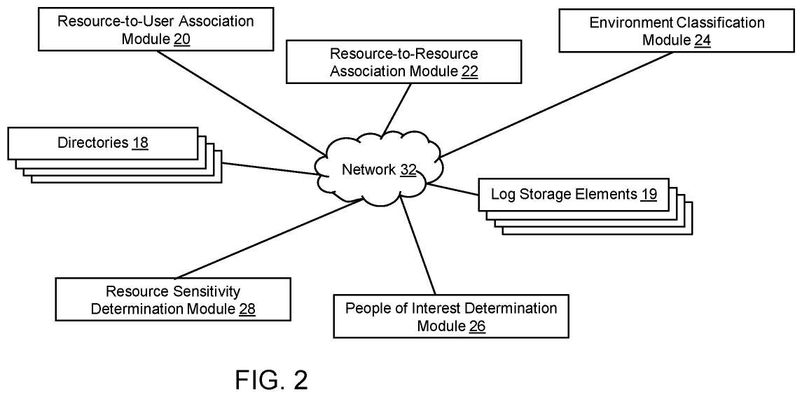

It is noted that all of the components that are part of or used by the system 10 as illustrated in FIG. 1 are electronically or communicatively coupled (e.g., connected) to each other, either directly or indirectly. It is further noted that one or more of the modules 20 may be communicatively coupled to each other via a network. FIG. 2 illustrates an example environment in which a system according to an embodiment of the present disclosure can be deployed in a distributed manner, in which the modules 22, 24, 26, 28, 30, as well as the directories 18 and the log storage elements 19 are communicatively coupled to each other via a network 32, which may be formed of one or more communication networks, including for example, the Internet, cellular networks, wide area, public, and local networks.

The following paragraphs describe the logic functions performed by the various modules 20 (computer components) that are part of, or communicatively coupled to, the system 10, including the resource-to-user association module 22, the resource-to-resource association module 24, the environment classification module 26, the user of interest determination module 28, and the resource sensitivity determination module 30. As will become apparent, the resource sensitivity determination module 30 utilizes the logic functions performed by the resource-to-user association module 22, the resource-to-resource association module 24, the environment classification module 26, and the user of interest determination module 28 in order to determine sensitivity of resources.

In general, a resource could be associated with one or more users. The resource-to-user association module 22 functions to determine whether a resource is associated with one or more users. The resource-to-user association module 22 may determine an association of a resource with a user based on inferencing made from metadata information associated with the resource including one or more of: i) permission information which indicates that the user is permitted to create, modify or delete the resource, ii) headers or trailers of transmission protocols indicating that the user is involved in the transmission of the resource, iii) headers or trailers found on the resource identifying the user, such as, for example, RFC822 headers such as “From”, “To”, “Cc”, “Bcc” indicating the user as the recipient or sender of an email, and iv) tags associated with the resource identifying the user.

The resource-to-user association module 22 may also determine (or infer) association of a resource to a user from logs with which the resource is associated. Specifically, a resource could be associated with a user if the resource and user are identified in the same log.

Thus, according to certain embodiments the resource-to-user association module 22 may receive as input from one or more of the directories 18 metadata information associated with a resource, and process the received metadata information to determine an association between the resource and one or more users. In other embodiments, the resource-to-user association module 22 may receive as input from one or more of the log storage elements 19 one or more logs, and process the received logs to determine an association between the resource and one or more users. It is noted that these two embodiments are not mutually exclusive, and in certain embodiments the resource-to-user association module 22 may receive input from both the directories 18 and the log storage elements 19 and process both the metadata information and logs to determine association between the resource and one or more users.

As will be discussed, the resource-to-user association module 22 may provide output (in the form of a determined association between a resource and a user) to the resource sensitivity determination module 30. In certain embodiments the resource-to-user association module 22 may also receive input from the resource sensitivity determination module 30.

In general, a first resource could be associated with a second resource. The resource-to-resource association module 24 functions to determine whether one resource is associated with another resource. To determine if such an association exists, according to certain embodiments of the present invention the resource-to-resource association module 24 checks for the existence of one or more of the following conditions: i) if the first and second resource belong to the same group of resources, ii) if the first and second resource share the same environment, iii) if the first and second resource are tagged similarly, iv) if the first and second resource are stored together, v) if the first and second resource share the same networking environment including, for example, the same subnet, vi) if the number of logs associated with the first and second resource over a pre-configured period of time exceeds a threshold, vii) if the ratio of logs associated with the first and second resource over a pre-configured period of time to the general number of logs in the same pre-configured period of time exceeds a pre-configured threshold, viii) if, according to logs, the size of the set of identities using both the first and second resource is above a predefined threshold, ix) if, according to logs and using a clustering algorithm, the two resources are found to belong to the same cluster or community. Examples of suitable clustering algorithms include Density-based spatial clustering of applications with noise (DBSCAN) by Martin Ester, Hans-Peter Kriegel, Jorg Sander and Xiaowei Xu, or a community detection algorithm, such as the Louvain Method by Blondel, et al.

Using one or more of the above conditions, according to certain embodiments the resource-to-resource association module 24 can make a determination if a first resource is associated with a second resource. This determination can be performed, for example, as a weighted average, using pre-configured weights over the output of the one or more conditions from the above list.

It should be apparent that the checking for existence of some of the conditions from the above list is based on metadata information associated with resources that is present in one or more of the directories 18, whereas the checking for the existence of other conditions from the above list is based on logs (which can include metadata information) that are stored in one or more of the log storage elements 19. Thus, in certain embodiments the resource-to-resource association module 24 may receive as input from one or more of the directories 18 metadata information associated with a resource, and process the received metadata information to check for existence of a metadata information-based conditions. In other embodiments, the resource-to-resource association module 24 may receive as input from one or more of the log storage elements 19 one or more logs, and process the received logs to check for existence of a log-based conditions. It is noted that these two embodiments are not mutually exclusive, and in certain embodiments the resource-to-resource association module 24 may receive input from both the directories 18 and the log storage elements 19 and process both the metadata information and logs to check for existence of conditions.

As will be discussed, the resource-to-resource association module 24 may provide output (in the form of a determined association between a first resource and a second resource) to the resource sensitivity determination module 30. In certain embodiments the resource-to-resource association module 24 may also receive input from the resource sensitivity determination module 30.

The environment classification module 26 functions to classify the type of environment to which a resource belongs. The environment classification module 26 is configured to receive as input resource identifiers and metadata information associated with resources. For a given received resource identifier, the environment classification module 26 retrieves (for example from one or more of the directories 18) metadata information associated with the resource that is identified by the received resource identifier. Specifically, the metadata information retrieved by the environment classification module 26 may include one or more of the following metadata information associated with the resource: i) tags or labels, ii) the name of the one or more resource groups to which the resource belongs, and iii) the project or subscription to which the resource belongs.

The environment classification module 26 functions to check the retrieved metadata information associated with the resource to determine if the metadata information matches one or more pre-configured string patterns and produces one or more matched patterns. For example, it is customary to tag resources belonging to development environment, staging/testing environment, and production environment with tags containing the values “dev”, “stage”, “prod”, respectively. As such, a resource associated with a tag whose value contains the string (or substring) “prod” is likely to belong to a production environment.

In certain embodiments, the set of patterns may be pre-programmed, while in other embodiments the set of patterns may be input by a user of the system 10. According to certain embodiments, the string patterns may be represented as literal strings, regular expressions, wildcards or a combination thereof.

In certain embodiments, the environment classification module 26 is further configured to receive as input logs associated with resources. In such embodiments, for a given received resource identifier the environment classification module 26 retrieves or receives one or more logs (for example from one or more of the log storage elements 19) that are associated with the resource that is identified by the received resource identifier. The environment classification module 26 functions to use the retrieved or received logs to identify patterns of use of the resource (thereby producing one or more identified patterns of use). The environment classification module 26 could apply any suitable pattern identification algorithm or technique on the retrieved or received logs to identify patterns of use of the resource, including, for example: i) spectrum analysis as described in Spectral Analysis of Signals by Petre Stoica and Randolph Moses (which is incorporated by reference), and ii) Seasonal and Trend decomposition using Loess (STL) decomposition, as described in Cleveland, R. B., Cleveland, W. S., McRae, J. E., & Terpenning, I. J. (1990). STL: A seasonal-trend decomposition procedure based on loess. Journal of Official Statistics, 6(1), 3-33 (https://www.scb.se/contentassets/ca21efb41fee47d293bbee5bf7be7fb3/stl-a-seasonal-trend-decomposition-procedure-based-on-loess.pdf) (which is incorporated by reference).

It should be appreciated that resources in different environments are expected to show different patterns of use. For example, while resources within a development environment are likely to be used during the office hours of the development center, resources within a production environment are likely to be used more intensively and over extended hours especially when production environments serve users spread across multiple time zones.

The environment classification module 26 further functions to make a determination on the type of environment to which the resource is likely to belong. This determination is based at least on the matched patterns, and in certain embodiments is further based on the identified patterns of use. This determination can be performed, for example, as a weighted average, using pre-configured weights over the output of the pattern matching and identified pattern of use.

As will be discussed, the environment classification module 26 may provide output (in the form of a determined type of environment to which a resource belongs, as well as whether the determined type of environment is classified as sensitive) to the resource sensitivity determination module 30. In certain embodiments the environment classification module 26 may also receive input from the resource sensitivity determination module 30.

As mentioned above, a user may refer to an actual person (i.e., human user) utilizing a computer system or a service, as well as an automatic agent working in a similar fashion. In addition, in certain embodiments the resource sensitivity determination module 30 determines sensitivity of a resource based in part on whether the electronic resource is associated with users of interest, in particular one or more users classified as users of interest. The user of interest determination module 28 functions to determine or identify a group of users of interest within the organization (so as to generate a group of people of interest). Preferably, each user of interest in the group is also associated with a list of one or more labels indicating the reason for that person being of interest.

According to certain preferred embodiments, the user of interest determination module 28 is configured to identify/determine a group of users of interest within the organization using an organizational chart that represents relationships between the human users in the organization (i.e., members of the organization). An organizational chart (referred to interchangeably herein as an “org chart”) is a directed acyclic graph having nodes that represent the set of members (e.g., employees) of an organization or a subset of the members of an organization. In such a graph, a directed edge typically exists from a tail node (T) to a head node (H) if the member represented by the tail node (T) directly manages (or oversees, or is responsible for) the member represented by the head node (H).

An org chart can be easily created, for example, by obtaining the list of members (e.g., employees) and their management relationship (i.e. who manages/oversees who) from any directory used by the organization for storing such information. The org chart could be represented in various well-known formats such as an adjacency matrix or an incidence matrix. In certain embodiments, the user of interest determination module 28 is configured to receive such an aforementioned list and generate the org chart or a representation thereof, whereas in other embodiments the user of interest determination module 28 is configured to receive the org chart or representation thereof. The org chart, or the information used to generate the org chart (e.g., the list of members and their management relationship), can be maintained/stored, for example, in one or more directories used by the organization. Such one or more directories are linked to the system 10 and/or the user of interest determination module 28, such that the org chart and/or the information used to generate the org chart is provided to the user of interest determination module 28 as input.

An org chart typically consists of a single tree, or alternatively as a set of trees (i.e. a forest). Each of the one or more trees in the org chart graph is associated with a root node, i.e. a node which is not the tail node of any edge. The user of interest determination module 28 can identify root nodes in a forest, which can be easily accomplished. For example, when using an adjacency matrix, the user of interest determination module 28 can identify such root nodes by the fact that all entries in the column representing the root node in the matrix are set to 0. Such a root node typically represents the top managing member of the organization, such as the CEO of the organization.

Similarly, a node is considered a leaf node if it is not the head node of any edge. The user of interest determination module 28 can identify leaf nodes in a forest, which can be easily accomplished. For example, when using an adjacency matrix, the user of interest determination module 28 can identify such leaf nodes by the fact that all entries in the row representing the node in the matrix are set to 0. Such a node typically represents members (e.g., employees) that do not manage other members.

It should be appreciated that given a node in the org chart, the user of interest determination module 28 can easily determine the distance from any of the root nodes to the given node. This could, for example, be accomplished by using any suitable algorithm such as Dijkstra's algorithm or the Bellman-Ford algorithm.

It should also be appreciated that given a node in the org chart, the user of interest determination module 28 can easily determine the distance from the given node to any of the leaf nodes. This could, for example, be accomplished by using any suitable algorithm such as Dijkstra's algorithm or the Bellman-Ford algorithm. In addition, the user of interest determination module 28 can determine the distance from the given node to the closest leaf node, for example by computing the minimum across all distances of the given node to each of the leaf nodes.

It should also be appreciated that given a node representing a member in the org chart, the user of interest determination module 28 can determine the number of members managed directly or indirectly by the member represented by the given node.

This number would correspond to one less than the number of nodes in the subtree whose root node is the given node representing the member.

Using an org chart, the user of interest determination module 28 can determine if a given member (e.g., a given employee) is of interest, thereby classifying the given member as a member of interest. The user of interest determination module 28 can make such a determination by using one or more of the following conditions: i) whether the number of members managed by the given member is above a preconfigured threshold, ii) whether the distance from a root node to the node representing the given member is below a preconfigured threshold, and iii) whether the distance of the node representing the given member to the closest leaf node is above a preconfigured threshold.

In certain embodiments, the user of interest determination module 28 can utilize additional information, such as information about a member found in one or more member directories, either instead of or in addition to the above-described org chart analysis to assist in determining whether a given member is of interest. For example, the user of interest determination module 28 can also take into account one or more of the following information and conditions: i) a member rank as assigned by the organization to the member and whether the rank is above a preconfigured threshold, ii) an employee salary and whether the salary is above a preconfigured threshold, iii) a member title and whether the title is found in a pre-configured list of titles, iv) an importance attribute as assigned by the organization to the member, v) whether the member is a member of a department pre-configured as a department of interest (e.g., members/employees in the legal department, financial department, etc.), vi) the type of resources the user (member) has access to or has actually accessed (for example, a user that has access to a sensitive resource such a keyvault or has actually accessed such a resource as is evident from activity logs could be determined to be of interest). The one or more directories that maintain the information about the member(s) can be the same directory or directories used to generate the org chart or can be a different directory or directories. Such one or more directories can include, for example, user or member records, department records (such as HR records, Finance department records related to users or members, for example payroll records, etc.), public information about people represented by user or member records, and the like. Parenthetically, such information can also be stored in one or more of the directories 18. Thus, in certain embodiments, the one or more directories 18 can store metadata information associated with resources as well as information about the user(s) and/or member(s) that are part of or are associated with the organization. Such an embodiment is illustrated in FIG. 1, whereby a direct link between the user of interest determination module 28 and the one or more directories 18 is illustrated. It should be apparent, however, that in embodiments in which the information about the user(s) and/or member(s) is stored in one or more member directories that are separate from the one or more directories 18, such one or more member directories would be linked (preferably but not necessarily directly linked) to the user of interest determination module 28.

Thus, it should be appreciated that using an org chart and possibly additional information found in a member directory, the user of interest determination module 28 can determine if a user is of interest.

It should be appreciated that when incorporating the one or more above mentioned conditions the final determination by the user of interest determination module 28 on whether a user is determined to be of interest or not could be made if the number of the satisfied conditions out of the one or more above mentioned conditions is above a pre-configured threshold such that if the threshold is crossed, the user is determined to be of interest, whereas if the threshold is not crossed, the user is determined to not be of interest.

Thus, using the above-described logic functions performed by the user of interest determination module 28, each member in an organization could be determined to be of interest or not to be of interest and a set/group of users that are classified to be users of interest could be generated and output.

It should also be appreciated that the generation of the group of users of interest by the user of interest determination module 28 is typically context dependent and typically specifically depends on any additional information input to the user of interest determination module 28. For example, in one instance where the user of interest determination module 28 performs logic functions to identify users of interest, the list of pre-determined departments of interest could consist of the HR department, whereas in a second instance, the list of pre-determined departments of interest could consist of the Finance department.

If a user is determined to be of interest, a list of labels is derived indicating the reasons for the user to be determined to be of interest. In certain embodiments, the user of interest determination module 28 is configured to derive the list of labels. The list of labels is derived based on one or more of: i) any label assigned for that purpose in the directory in which the user is defined, ii) any label associated with the department with which the user is associated, iii) one or more of the rank, title, or role of the user, where the rank, title or role is used as a key in a pre-configured look up table providing zero or more lists of labels, iv) the types of resources that the user has access to or has actually accessed are used as keys in a pre-configured look up table providing zero or more lists of labels.

In certain embodiments, the list of labels could be derived as the union of the above lists of labels.

It is noted that the above description of org charts is applicable to any type of organization where there is a hierarchical relationship between members, including, for example, corporate organizations in which the members of the organization are employees or external contractors and there exists a hierarchical management structure between members, non-corporate organizations such as military or law enforcement organizations in which the members of the organizations are military or law enforcement personnel and there exists a hierarchical rank structure between the personnel, and the like.

As will be discussed, the user of interest determination module 28 may provide output (in the form of a generated group of users of interest, for example generated from an org chart) to the resource sensitivity determination module 30. In certain embodiments the user of interest determination module 28 may also receive input from the resource sensitivity determination module 30.

The resource sensitivity determination module 30 functions to determine sensitivity of resources. The resource sensitivity determination module 30 is configured to receive as input various sets and to determine sensitivity of resources based on the received inputs. In particular, the resource sensitivity determination module 30 is configured to receive as input a first set of resource identifiers, a second set of resource identifiers, a set of users, and a set of zero or more logs. The resource sensitivity determination module 30 is preferably further configured to receive input from and provide output to the various other modules 22, 24, 26, 28.

The first set of resource identifiers (also referred to as a “first identifier set”, or “the universe of resource identifiers”) is a set that consists of one or more resource identifiers that identify resources whose sensitivity is to be determined by the system 10 and for which the reasons for such sensitivity should be classified. This set could include all resources visible to the system 10.

The second set of resource identifiers (also referred to as a “second identifier set”, or “the labeled set of resource identifiers”) is a set that consists of zero or more resource identifiers that identify resources that have been pre-determined to be sensitive (i.e., resources that are already classified as sensitive). For each resource identifier, one or more labels indicating the reasons for such sensitivity is also provided.

The set of users consists of zero or more users in the organization that have been pre-determined to be of interest (i.e., users that are already classified as being users of interest). For each user, one or more labels indicating the reasons why such a user is of interest is also provided.

The set of zero or more logs consists of logs that are related to or associated with the resources identified by the resource identifiers in the first identifier set.

The resource sensitivity determination module 30 preferably receives from the user of interest determination module 28 a generated group of users of interest, for example generated by the user of interest determination module 28 from an org chart, as well as the corresponding list of labels that indicates the reasons for the users in the group to be determined to be of interest. The resource sensitivity determination module 30 may also add the received generated group of users of interest to the set of users along with the corresponding list of labels.

In general, the resource sensitivity determination module 30 functions to operate iteratively over each resource identifier in the first identifier set. For each resource identifier in the first identifier set, the resource sensitivity determination module 30 preferably makes the following determinations and computations with respect to the resource that is identified by the resource identifier: i) determine if the resource is associated with one or more other resources that are identified by resource identifiers that are in the second identifier set. The making of such a determination can be performed by the resource-to-resource determination module 24, using the techniques described above, as tasked by the resource sensitivity determination module 30. In certain embodiments, as described above, the determination can be assisted by the set of zero or more logs provided as input and using the process described above for making such a determination; ii) determine to which environment the resource belongs and whether that environment is determined to be sensitive. The making of such a determination can be performed by the environment classification module 26, using the techniques described above, as tasked by the resource sensitivity determination module 30; and iii) compute the number of users that are associated with the resource and are found in the set of users. The computed number is then checked against a pre-configured threshold.

Using the one or more of the above determinations and computations, the resource sensitivity determination module 30 according to embodiments of the present invention can make a determination if a first resource is sensitive. In particular, the resource sensitivity determination module 30 determines if the first resource is sensitive based on a combination of the determined association from i) above, determined type of environment from ii) above, and computed number of users from iii) above. In certain embodiments, the resource sensitivity determination module 30 makes the determination as a weighted combination of the outputs from i), ii), and iii), for example as a weighted average, using pre-configured weights over the output of the one or more determinations and computations from the above i), ii), and iii).

If the resource sensitivity determination module 30 determines that a resource is sensitive, a list of labels is derived indicating the reasons for the resource to be determined to be sensitive. Preferably the resource sensitivity determination module 30 is configured to derive the list of labels. The list of labels can be derived based on one or more of: i) the lists of labels associated with the resources from the second identifier set that are found to be associated with the resource, and ii) the lists of labels of the users that are associated with the resource and are found in the set of users. The list of labels could be derived as the union of the above lists of labels. These labels, and hence the reasons indicated by the labels, provide a level of sensitivity of an electronic resource that has been determined to be sensitive.

In certain embodiments, if a resource is determined by the resource sensitivity determination module 30 to be sensitive, the resource sensitivity determination module 30 may prompt a user to confirm this determination. When prompting the user, the set of derived labels indicating the reasons for the resource to be determined to be sensitive could be provided to the user via a user interface (not shown in the drawings). The user interface can be any suitable computer-user interfacing arrangement, including a graphical user interface displayed on a screen connected to the system 10, a pop-up screen on a display connected to the system 10, and the like. Preferably, the user can select which labels, if any, indicate the reasons for the resource to be determined to be sensitive. The selection of labels by the user can also be performed using a user interface, such as a keyboard, mouse, microphone, etc. In certain embodiments, the user's response can be optionally recorded (for example in a memory associated with the system 10, such as storage/memory 14) for future improvements of the system 10.

If the user indicates that the resource is not sensitive, the resource sensitivity determination module 30 determines that the resource is not sensitive (i.e., the user response has the potential to override any initial determination made by the resource sensitivity determination module 30). The resource sensitivity determination module 30 then removes the resource identifier that identifies the resource from the second identifier set.

If the resource sensitivity determination module 30 determines that a resource is sensitive, and this determination is confirmed by a user or if a user was not prompted to confirm this determination, the resource sensitivity determination module 30 performs the following actions: i) removes the resource identifier that identifies the resource from the first identifier set, and ii) adds the resource identifier that identifies the resource along with the list of labels confirmed by the user or the original list of labels if a user was not prompted, to the second identifier set.

As mentioned, the resource sensitivity determination module 30 functions to operate iteratively over each resource identifier in the first identifier set. In particular, the resource sensitivity determination module 30 functions to iterate on the resource identifiers in the first identifier set a number of iterations, at each iteration using a selected resource identifier different from the selected resource identifier used in the previous iteration, until at least one stopping condition is satisfied. If after iterating over all resource identifiers in the first identifier set, the first identifier set is empty or the second identifier set was not updated from the previous iteration, the resource sensitivity determination module 30 outputs the updated second identifier set with their lists of labels and then stops (here the stopping condition is satisfied if the first identifier set is empty or if the second identifier set is not updated).

If after iterating over all resource identifiers in the first identifier set there still remain entries in the first identifier set, the resource sensitivity determination module 30 checks for another stopping condition. This stopping condition may be based on one or more of the following conditions: if the number of iterations over the first identifier set exceeds a pre-configured value (i.e., that the first identifier set is not to be iterated over more than a pre-configured number of times), ii) if the number of resources determined to be sensitive exceeds a pre-configured value.

It should be noted that the above stopping condition could be composed of a combination of the above-mentioned stopping conditions and that for the stopping condition to be met a pre-configured subset of the conditions should all be met or at least one of a pre-configured subset of the conditions needs to be met.

If the stop condition has been met, the resource sensitivity determination module 30 outputs the updated second identifier set with the corresponding lists of labels and then stops iterating on the first identifier set. If the stop condition has not been met, the resource sensitivity determination module 30 restarts iterating over the remaining resource identifiers in the first identifier set.

Attention is now directed to FIG. 3 which shows a flow diagram illustrating a computer-implemented (i.e., a computerized) process (i.e., method) 300 in accordance with embodiments of the disclosed subject matter. This computer-implemented process 300 is an iterative process, and includes an algorithm for determining sensitivity of electronic resources. The algorithm can also be described as classifying electronic resources as sensitive/non-sensitive. Reference is also made to FIGS. 1 and 2 and the components illustrated therein. The process and sub-processes of FIG. 3 are computerized processes performed by the system 10, including, for example, the CPU 12 and associated components, such as the resource-to-user association module 22, the resource-to-resource association module 24, the environment classification module 26, the user of interest determination module 28, and the resource sensitivity determination module 30. The aforementioned processes and sub-processes are for example, performed automatically by the system 10, and are performed, for example, in real-time. As will become apparent from the subsequent description of the process 300, as the process 300 progresses through its iterations, resource identifiers are moved from the first identifier set to the second identifier set. In other words, resource identifiers in the first identifier set are classified as sensitive.

The process 300 begins at step 302, where the resource sensitivity determination module 30 receives inputs, including the first identifier set, the second identifier set, the set of users that consists of zero or more users in the organization that have been pre-determined to be of interest (and the corresponding one or more labels indicating the reasons why such a user is of interest), and the set of zero or more logs that consists of logs that are related to or associated with the resources identified by the resource identifiers in the first identifier set.

At step 304, the user of interest determination module 28 generates a group of users of interest and provides that generated group to the resource sensitivity determination module 30 together with the corresponding list of labels that indicates the reasons for the users in the generated group to be determined to be of interest. At step 306 the resource sensitivity determination module 30 adds the received generated group of users of interest to the set of users (received at block 302) along with the corresponding list of labels. It is noted that step 304 can be performed prior to or in parallel with step 302.

The process 300 then moves to step 308, where the resource sensitivity determination module 30 selects a resource identifier in the first identifier set as a selected resource identifier.

The process then moves to steps 310, 312, 314. The order in which the steps 310, 312, 314 are performed is not critical. For example, the steps 310, 312, 314 can be performed sequentially (for example in the order illustrated in FIG. 3 or in any other order). Alternatively, the steps 310, 312, 314 can be performed in parallel. Further still, two of the steps 310, 312, 314 can be performed in parallel immediately before or immediately after the other of the steps 310, 312, 314.

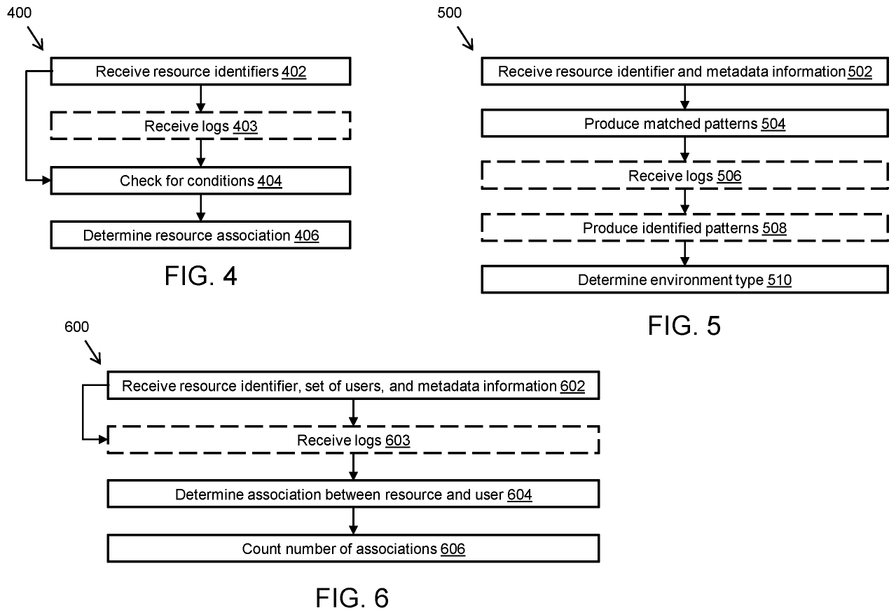

At step 310, the resource sensitivity determination module 30 determines if the resource identified by the selected resource identifier is associated with one or more other resources that are identified by resource identifiers that are in the second identifier set. As mentioned above, the making of such a determination can be performed by the resource-to-resource determination module 24, using the techniques described above, and as tasked by the resource sensitivity determination module 30. In certain embodiments, as described above, the determination can be assisted by the set of zero or more logs provided as input and using the process described above for making such a determination. Details of the sub-steps of step 310 will be described with reference to FIG. 4.

At step 312, the resource sensitivity determination module 30 determines the type of environment to which the resource identified by the selected resource identifier belongs and whether that environment is classified as (i.e., determined to be) sensitive. The making of such a determination can be performed by the environment classification module 26, using the techniques described above, and as tasked by the resource sensitivity determination module 30. Details of the sub-steps of step 312 will be described with reference to FIG. 5.

At step 314, the resource sensitivity determination module 30 computes (i.e., calculates, determines) the number of users that are associated with the resource identified by the selected resource identifier and are found in the set of users. In one non-limiting embodiment, the computed number is then checked against a pre-configured threshold. In other embodiments, other information pertaining to or associated with the users that are associated with the resource identified by the selected resource identifier is utilized to compute the number of users. For example, the type of user can be taken into account when computing the number of users. For example, users of higher importance than other users of interest may be counted as more than one user. As another example, the association of a user that is associated with the resource identified by the selected resource identifier can be provided a weight or a strength. For example, the CEO of an organization that is associated with the resource identified by the selected resource identifier can be assigned a higher weight than a member of the HR department that is also associated with the resource identified by the selected resource identifier.

Details of examples of sub-steps of step 314 will be described with reference to FIG. 6.

The process 300 then moves to step 316, where the outputs from steps 310, 312, 314 are combined by the resource sensitivity determination module 30 in order to determine (i.e., classify) a sensitivity of the resource that is identified by the selected resource identifier. As discussed above, the combination can be a weighted combination, for example a weighted average using pre-configured weights over the output from steps 310, 312, 314.

Parenthetically, it is noted that strictly speaking not all of the outputs of the steps 310, 312, 314 need be used in the combination, and thus at least one of the steps 310, 312, 314 need be performed in order to determine sensitivity of a resource. For example, in certain cases it may be preferable that only the outputs of the steps 310, 312 be used in combination to determine sensitivity of the resource, whereas in other cases only the output of one of the steps may be utilized to determine sensitivity of a resource. However, certain preferred embodiments rely on using all three outputs from the steps 310, 312, 314 in order to determine sensitivity of resources.

The process 300 then executes a decision step 318, checking whether or not the resource identified by the selected resource identifier is determined to be sensitive by the resource sensitivity determination module 30. If the resource is determined to be sensitive the process 300 moves to block 320 where a list of labels is derived (for example by resource sensitivity determination module 30) indicating the reasons for the resource to be determined to be sensitive. It should be apparent that steps 316 and 318 can be executed as a single step.

The process 300 may optionally move to step 322 and prompt a user to confirm the determination of sensitivity. As mentioned above, when prompting the user, the set of derived labels indicating the reasons for the resource to be determined to be sensitive could be provided to the user, and the user can select which labels, if any, indicate the reasons for the resource to be determined to be sensitive. The process 300 then executes a decision step 324, checking whether or not the user indicates that the resource is sensitive. If the user indicates that the resource is not sensitive (i.e., the user overrides the determination as sensitive at step 316), the process 300 moves to step 326 where the selected resource identifier is removed from the first identifier set. The process 300 then moves from step 326 to step 330. If the user indicates that the resource is sensitive, the process 300 moves from step 324 to step 328.

If the resource sensitivity determination module 30 determines at step 316 that the resource is not sensitive, the process 300 moves from step 318 to step 330. Parenthetically, it is noted that if the resource sensitivity determination module 30 determines at step 316 that the resource is not sensitive, the selected resource identifier that identifies the resource is not removed from the first identifier set. The rationale for keeping the selected resource identifier in the first identifier set is that in a future iteration this resource could be determined to be sensitive due to one or more other associated resources being determined to be sensitive.

If the resource sensitivity determination module 30 determines that the resource is sensitive and the user is not prompted for feedback, the process 300 moves from step 320 to step 328.

At step 328, the selected resource identifier is removed from the first identifier set, and is added to the second identifier set (along with the list of labels confirmed by the user or the original list of labels if a user was not prompted). The process 300 then moves from step 328 to step 330.

At step 330, the resource sensitivity determination module 30 checks for a first stopping condition, in particular if the first identifier set is empty or if the second identifier set is not updated (relative to one or more previous iterations, and if no previous iterations occurred then relative to the second identifier set input at step 302). If the stopping condition at step 330 is satisfied, the process 300 moves to step 332, where the resource sensitivity determination module 30 outputs the updated second identifier set with the corresponding lists of labels. The process 300 then moves to step 334 and ends (terminates/stops).

If the stopping condition at step 330 is not satisfied (i.e., if there still remain entries in the first identifier set, for example after iterating over all resource identifiers in the first identifier set), the process 300 checks for another stopping condition at step 336. As discussed above, the existence of the stopping condition at step 336 may be based on one or more of the following conditions: if the number of iterations over the first identifier set exceeds a pre-configured value (i.e., that the first identifier set is not to be iterated over more than a pre-configured number of times), ii) if the number of resources determined to be sensitive exceeds a pre-configured value.

If the stopping condition at step 336 is satisfied, the process 300 moves to step 332 and subsequently to step 334. If the stopping condition at step 336 is not satisfied, the process 300 returns to step 308 and selects a new selected resource identifier and then executes the remaining subsequent steps of the process 300.

It is noted that in certain situations, the resource sensitivity determination module 30 may not be able to definitively determine whether or not the resource identified by the selected resource identifier is sensitive. In other words, step 316 may result in the resource sensitivity determination module 30 producing an output that does not indicate whether the resource is sensitive. This may be due to the resource sensitivity determination module 30 not having enough information to categorically decide on the sensitivity of the resource, or may be due to the resource sensitivity determination module 30 having conflicting information, for example some information being indicative of the resource being sensitive and other information being indicative of the resource not being sensitive. In such situations, when the process 300 reaches the decision step 318, the outcome of the decision step 318 can be “unsure”, and the process 300 returns to step 308 to operate (iterate) on the next resource.

Attention is now directed to FIG. 4 which shows a flow diagram illustrating a computer-implemented (i.e., a computerized) process (i.e., method) 400 in accordance with embodiments of the disclosed subject matter. This computer-implemented process 400 details the steps for executing step 310 of the process 300. The processes and sub-processes of the process 400 of FIG. 4 are computerized processes performed by the system 10, including, for example, the CPU 12 and associated components, such as the resource-to-resource determination module 24 and the resource sensitivity determination module 30.

The process 400 begins at step 402, where the selected resource identifier and each resource identifier in the second identifier set is provided to the resource-to-resource determination module 24. The process 400 then moves to block 404, where, for each resource identifier in the second identifier set the resource-to-resource determination module 24 checks for the existence of one or more conditions.

Optionally, prior to checking for existence of the conditions at step 404 the process 400 may execute step 403 and receive the set of logs provided as input at step 302 of the process 300.

If step 403 is not executed, the conditions include: i) if the first and second resource belong to the same group of resources, ii) if the first and second resource share the same environment, iii) if the first and second resource are tagged similarly, iv) if the first and second resource are stored together, v) if the first and second resource share the same networking environment including, for example, the same subnet.

If step 403 is executed, the conditions may also include: vi) if the number of logs associated with the first and second resource over a pre-configured period of time exceeds a threshold, vii) if the ratio of logs associated with the first and second resource over a pre-configured period of time to the general number of logs in the same pre-configured period of time exceeds a pre-configured threshold, viii) if, according to logs, the size of the set of identities using both the first and second resource is above a predefined threshold, ix) if, according to logs and using a clustering algorithm, the two resources are found to belong to the same cluster or community.

At step 406, for each resource identifier in the second identifier set the resource-to-resource association module 24 makes a determination if the resource identified by the selected resource identifier is associated with the resource that is identified by the resource identifier in the second identifier set. As discussed above, this determination can be done for example as a weighted average, using pre-configured weights over the output of the one or more conditions from the above list. This determination can be provided back to the resource sensitivity determination module 30.

Attention is now directed to FIG. 5 which shows a flow diagram illustrating a computer-implemented (i.e., a computerized) process (i.e., method) 500 in accordance with embodiments of the disclosed subject matter. This computer-implemented process 500 details the steps for executing step 312 of the process 300. The processes and sub-processes of the process 500 of FIG. 5 are computerized processes performed by the system 10, including, for example, the CPU 12 and associated components, such as the environment classification module 26 and the resource sensitivity determination module 30.

The process 500 begins at step 502, where the selected resource identifier and metadata information associated with the resource identified by the selected resource identifier is provided to the environment classification module 26. The metadata information can be provided by the resource sensitivity determination module 30 upon retrieval from one or more of the directories 18, or can be received directly by the environment classification module 26 from the directories 18.

At step 504, the environment classification module 26 checks the metadata information associated with the resource to see if the metadata matches one or more pre-configured string patterns, to produce one or more matched patterns.

Optionally at step 506 the environment classification module 26 can receive the set of logs provided as input at step 302 of the process 300. At step 508 the environment classification module 26 analyzes the logs to identify patterns of use of the resource (thereby producing one or more identified patterns of use).

At step 510, the environment classification module 26 makes a determination on the type of environment to which the resource is likely to belong based at least on the matched patterns, and in certain embodiments further based on the identified patterns of use. This determination can be done as a weighted average, using pre-configured weights over the output of the pattern matching and identified pattern of use. The determination can also include an indication of the sensitivity of the determined type of environment. For example, a production environment may be more sensitive than a staging environment or a development environment. The determination output can be provided back to the resource sensitivity determination module 30 is input.

Attention is now directed to FIG. 6 which shows a flow diagram illustrating a computer-implemented (i.e., a computerized) process (i.e., method) 600 in accordance with embodiments of the disclosed subject matter. This computer-implemented process 600 details the steps for executing step 314 of the process 300. The processes and sub-processes of the process 600 of FIG. 6 are computerized processes performed by the system 10, including, for example, the CPU 12 and associated components, such as the resource-to-user determination module 22 and the resource sensitivity determination module 30.

The process 600 begins at step 602, where the selected resource identifier, the set of users (provided as input at step 302 of the process 300), and metadata information associated with the resource identified by the selected resource identifier are provided to the resource-to-user determination module 22. The metadata information can be provided by the resource sensitivity determination module 30 upon retrieval from one or more of the directories 18, or can be received by the resource-to-user determination module 22 directly from the directories 18

The process 600 then moves to step 604, where, for each user in the set of users, the resource-to-user determination module 22 determines whether there is an association between the resource and the user based on the metadata information. For examples, and as discussed above, an association between the resource and the user can be inferred based on one or more of: i) permission information which indicates that the user is permitted to create, modify or delete the resource, ii) headers or trailers of transmission protocols indicating that the user is involved in the transmission of the resource, iii) headers or trailers found on the resource identifying the user, such as, for example, RFC822 headers such as “From”, “To”, “Cc”, “Bcc” indicating the user as the recipient or sender of an email, and iv) tags associated with the resource identifying the user.

At step 606, the resource-to-user determination module 22 counts the number of associations determined (or inferred) at step 604.

Optionally, the process 600 may execute step 603 in which the resource-to-user determination module 22 receives the set of logs provided as input at step 302 of the process 300. If step 603 is executed, step 604 may include the resource-to-user determination module 22 determining, for each user in the set of users, whether there is an association between the resource and the user by checking if the user and the resource are identified in a same log.

As mentioned above, in one non-limiting embodiment, the computed number is then checked against a pre-configured threshold. Also as mentioned, in certain embodiments other information pertaining to or associated with the users that are associated with the resource identified by the selected resource identifier is utilized to compute the number of users. For example, the type of user can be taken into account when computing the number of user. As another example, the association of a user that is associated with the resource identified by the selected resource identifier can be provided a weight or a strength.

The determined number of associations, i.e., the computed number of user associated with the resource identified by the selected resource identifier, can be provided back to the resource sensitivity determination module 30.

The subdivision of the logic and logic functions performed by the various computer modules 20 has been described herein according to a functional subdivision. It should be noted however that these functions may be subdivided in any desired manner, with one or more of the functions being performed by a particular one of the computer modules 20. For example, the resource sensitivity determination module 30 may be configured to perform some or all of the logic functions attributed to the computer modules 22, 24, 26, 28.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. A non-transitory computer readable (storage) medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowcharts and block diagrams in the accompanying drawings illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method, executed by a processor coupled to a non-transitory computer readable storage medium, for determining a sensitivity of electronic resources, the method comprising:
obtaining a first resource identifier that identifies a first electronic resource;
determining an association of the first electronic resource with one or more other electronic resources that are identified by resource identifiers in an identifier set, wherein the identifier set includes zero or more resource identifiers that identify electronic resources that are classified as sensitive;
determining a type of environment to which the first electronic resource belongs;
computing a number of users in a user set that are associated with the first electronic resource, wherein the user set includes zero or more users that are classified as users of interest; and
determining if the first electronic resource is sensitive based on a combination of the determined association, determined type of environment, and computed number of users.

2. The method of claim 1, wherein the first resource identifier is selected as a selected resource identifier from a set of resource identifiers, and wherein the method iterates on each resource identifier in the set of resource identifiers.

3. The method of claim 1, further comprising:
adding the first resource identifier to the identifier set if the first electronic resource is determined to be sensitive.

4. The method of claim 1, further comprising:
deriving at least one label that is indicative of at least one reason for the first electronic resource to be determined as sensitive.

5. The method of claim 1, wherein determining the association of the first electronic resource with the one or more other electronic resources that are identified by resource identifiers in the identifier set includes, for each one electronic resource of the one or more other electronic resources, performing one or more of: i) determining that the first electronic resource and the one electronic resource belong to a same group of electronic resources, ii) determining that the first electronic resource and the one electronic resource share a common environment, iii) determining that the first electronic resource and the one electronic resource have similar tags, iv) determining that the first electronic resource and the one electronic resource are stored together, and v) determining that the first electronic resource and the one electronic resource share a common networking environment.

6. The method of claim 1, further comprising:
receiving a plurality of logs, each log associated with at least one electronic resource and recording operations performed by or on the at least one electronic resource,
wherein determining the association of the first electronic resource with the one or more other electronic resources that are identified by resource identifiers in the identifier set includes, for each one electronic resource of the one or more other electronic resources, performing one or more of:
i) determining that a number of the plurality of logs that are associated with the first electronic resource and the one electronic resource over a pre-configured period of time exceeds a threshold,
ii) determining that a ratio between a number of the plurality of logs that are associated with the first electronic resource and the one electronic resource over a pre-configured period of time and a total number of the plurality of logs in the same pre-configured period of time exceeds a threshold,
iii) determining, based on the plurality of logs, that a size of a set of identities using both the first electronic resource and the one electronic resource is above a threshold, and
iv) applying a clustering algorithm to the plurality of logs, and determining, based on the clustering algorithm, that the first electronic resource and the one electronic resource belong to a same cluster or community.

7. The method of claim 1, wherein determining a type of environment to which the first electronic resource belongs includes:
retrieving metadata information associated with the first electronic resource,
checking the retrieved metadata information for matches with one or more string patterns to produce one or more matched patterns, and
determining the type of environment based at least on the one or more matched patterns.

8. The method of claim 7, wherein determining a type of environment to which the first electronic resource belongs further includes:
receiving at least one log associated with the first electronic resource and recording operations performed by or on the first electronic resource,
identifying one or more patterns of use of the first electronic resource from the received at least one log to produce one or more identified patterns, and
determining the type of environment based on a combination of the one or more matched patterns and the one or more identified patterns.

9. The method of claim 1, wherein computing the number of users in the user set that are associated with the first electronic resource includes:
for each user in the user set, determining an association with the first electronic resource based on metadata associated with the first electronic resource.

10. The method of claim 1, further comprising:
receiving at least one log associated with the first electronic resource and recording operations performed by or on the first electronic resource, and wherein computing the number of users in the user set that are associated with the first electronic resource includes:
for each user in the user set, determining that the user is associated with the first electronic resource if the user and the first electronic resource are identified in a same one of the at least one log.

11. The method of claim 1, wherein each user in the user set is selected from the group consisting of: a human user, and an automatic agent.

12. The method of claim 1, wherein at least some of the users in the user set are human users, and wherein each human user in the user set is classified as a user of interest based on analyzing an organizational chart that represents relationships between the human users in an organization.

13. The method of claim 1, wherein the combination is a weighted combination.

14. The method of claim 1, further comprising:
if the first electronic resource is determined to be sensitive, prompting a user to confirm the determination of sensitivity of the first electronic resource.

15. A method, executed by a processor coupled to a non-transitory computer readable storage medium, for determining a sensitivity of electronic resources, the method comprising the steps of:
a) obtaining a first identifier set that includes one or more resource identifiers that identify one or more corresponding electronic resources;
b) obtaining a second identifier set that includes zero or more resource identifiers that identify electronic resources that are classified as sensitive;
c) determining an association of the electronic resource identified by a selected resource identifier in the first identifier set with one or more other electronic resources that are identified by resource identifiers in the second identifier set;
d) determining a type of environment to which the electronic resource identified by the selected resource identifier in the first identifier set belongs;
e) computing a number of users in a user set that are associated with the electronic resource identified by the selected resource identifier in the first identifier set, wherein the user set includes zero or more users that are classified as users of interest;
f) determining if the electronic resource identified by the selected resource identifier in the first identifier set is sensitive based on a combination of the determined association, determined type of environment, and computed number of users; and
g) iterating steps c)-f) a number of iterations, at each iteration using a selected resource identifier different from the selected resource identifier used in the previous iteration, until at least one stopping condition is satisfied.

16. The method of claim 15, wherein satisfying the at least one stopping condition includes reaching a maximum number of iterations.

17. The method of claim 15, wherein satisfying the at least one stopping condition includes the first identifier set being empty or the second identifier set not being updated.

18. The method of claim 15, further comprising the step of: removing the resource identifier from the first identifier set and adding the resource identifier to the second identifier set if at step f) the electronic resource identified by the selected resource identifier in the first identifier set is determined to be sensitive.

19. The method of claim 18, wherein satisfying the at least one stopping condition includes a number of resource identifiers in the second identifier set exceeding a threshold value.

20. A method, executed by a processor coupled to a non-transitory computer readable storage medium, for determining a sensitivity of electronic resources, the method comprising:
obtaining a first resource identifier that identifies a first electronic resource;
performing one or more of:
determining an association of the first electronic resource with one or more other electronic resources that are identified by resource identifiers in an identifier set, wherein the identifier set includes zero or more resource identifiers that identify electronic resources that are classified as sensitive,
determining a type of environment to which the first electronic resource belongs, and
computing a number of users in a user set that are associated with the first electronic resource, wherein the user set includes zero or more users that are classified as users of interest; and
determining if the first electronic resource is sensitive based on a combination of one or more of the determined association, determined type of environment, and computed number of users.
